(19) United States
(12) Patent Application Publication
(10) Pub. No.: US 2020/0117317 A1
(43) Pub. Date: Apr. 16, 2020

(54) ENHANCED COMBO BOX ELEMENT FOR GRAPHICAL USER INTERFACE (GUI)

(71) Applicant: CA Software Österreich GmbH, Wien (AT)

(72) Inventors: Manuela Posch, Loipersbach (AT); Matjaz Gorican, Vienna (AT); Tobias Stanzel, Vienna (AT)

(73) Assignee: CA Software Österreich GmbH, Wien (AT)

(21) Appl. No.: 16/161,016

(22) Filed: Oct. 15, 2018

(51) Int. Cl. G06F 3/0482; G06F 3/0481; G06F 3/0484

(52) U.S. Cl. CPC G06F 3/0482; G06F 3/04847; G06F 3/04842; G06F 3/04817

(57) ABSTRACT

According to at least one embodiment, an interactive graphical user interface (GUI) is presented on a display coupled to a computing device, and the GUI includes a selection field for selection of one or more items. An interaction with the selection field is received, and a selection interface is presented in the GUI based on the interaction with the selection field. The selection interface includes a list of selectable items associated with the selection field and a list of selectable actions to be taken with respect to selection of an item for the selection field. A selection of a particular action in the list of selectable actions is received, and an action interface for performing the particular action is presented in the GUI based on the selection of the particular action.

### BACKGROUND

The present disclosure relates in general to the field of computing systems, and more specifically, to enhanced combo box elements for graphical user interfaces (GUIs) used by computing systems.

Combo box elements may be used in GUIs to allow a user of a computing system to choose between a list of selectable items. In some cases, a combo box element may include a drop-down list that shows the selectable items and a text input box for typing the value of a selectable item directly. Sometimes users of GUIs may discover, through a listing of options provided through a combo box element, that a desired option is either not present or incorrectly defined, which may necessitate having the user close the combo box element and navigate to another GUI or GUI element to address the issue. This can interrupt the user's workflow, causing the user to break concentration and lose valuable time.

### BRIEF SUMMARY

According to one aspect of the present disclosure, an interactive graphical user interface (GUI) is presented on a display coupled to a computing device, and the GUI includes a selection field for selection of one or more items. An interaction with the selection field is received, and a selection interface is presented in the GUI based on the interaction with the selection field. The selection interface includes a list of selectable items associated with the selection field and a list of selectable actions to be taken with respect to selection of an item for the selection field. A selection of a particular action in the list of selectable actions is received, and an action interface for performing the particular action is presented in the GUI based on the selection of the particular action.

According to another aspect of the present disclosure, user interaction with a data entry field of a graphical user interface (GUI) is detected, and a combo box element is generated near the data entry field in the GUI based on detection of the interaction. The combo box element includes a text input field, a list of selectable items, and a list of selectable actions to be taken with respect to selection of an item for the data entry field. A selection of a particular action in the list of selectable actions is detected, and an action element for performing the particular action is generated in the GUI based on selection of the particular action.

### BRIEF DESCRIPTION OF THE DRAWINGS

FIGS. 1A-1B are simplified diagrams of an example computing environment in accordance with at least one embodiment.

FIG. 2 is a diagram of an example enhanced combo box element of a graphical user interface (GUI) in accordance with at least one embodiment.

FIG. 3 is a diagram of another example enhanced combo box element of a graphical user interface (GUI) in accordance with at least one embodiment.

FIG. 4 is a diagram of an example action interface being generated in a GUI in response to selection of a selectable action in an enhanced combo box element for a data entry field in accordance with at least one embodiment.

FIG. 5A-5B is a diagram of example placeholder functionality in an enhanced combo box element of a GUI in accordance with at least one embodiment.

FIG. 6 is a diagram of example multiple selection functionality in an enhanced combo box element of a GUI in accordance with at least one embodiment.

FIG. 7 is a diagram of example nested list functionality in an enhanced combo box element of a GUI in accordance with at least one embodiment.

FIG. 8 is a diagram of example subtitles in an enhanced combo box element of a GUI in accordance with at least one embodiment.

FIG. 9 is a diagram of example icons in an enhanced combo box element of a GUI in accordance with at least one embodiment.

FIG. 10 is a diagram of an example selection interface element being generated in response to detection of an interaction with a data entry field in accordance with at least one embodiment.

FIG. 11 is a diagram of an example process of generating an enhanced combo box element in a GUI in accordance with at least one embodiment.

FIG. 12 is a diagram of an example process of generating a selection interface for a selected item in a data entry field in accordance with at least one embodiment.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “ module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

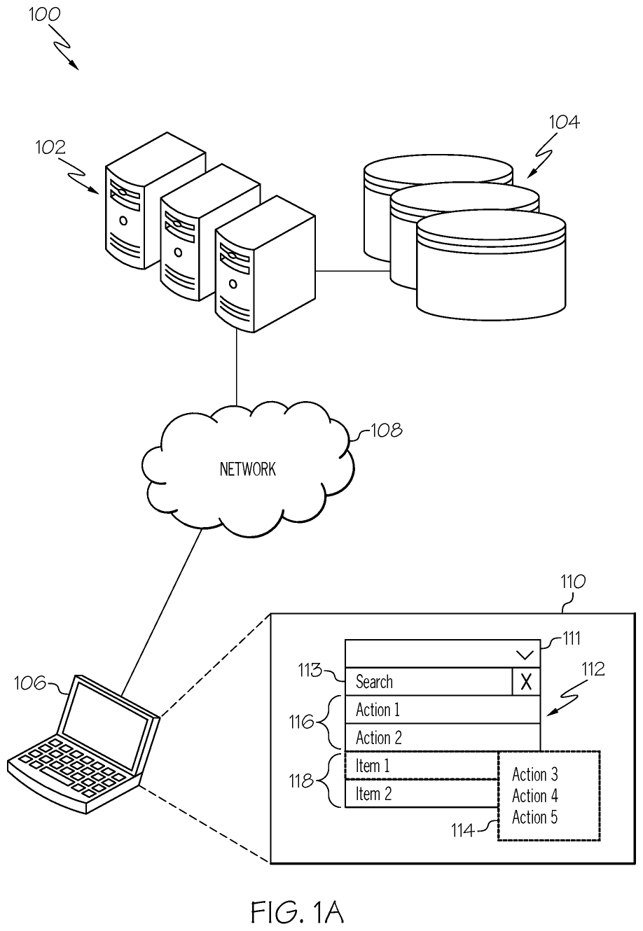

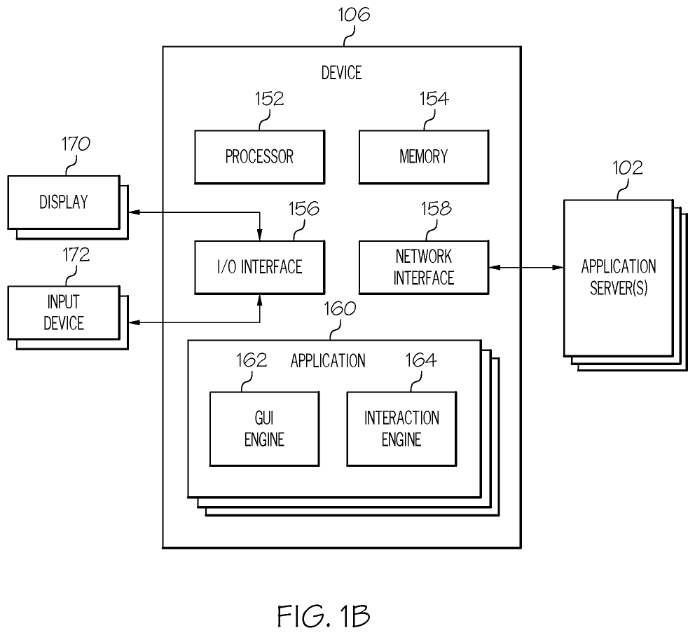

FIGS. 1A-1B are simplified diagrams of an example computing environment 100 in accordance with at least one embodiment. The computing environment 100 includes application servers 102 and a user device 106 communicably coupled to one another via a network 108. The application servers 102 may provide one or more services to the user device 106, which may act as a client. The application servers 102 are coupled to a database 104, which may be accessed by the application servers 102 during the provision of certain services to the user device 106.

As shown in FIG. 1A, the user device 106 may present a graphical user interface (GUI) 110 to a user of the device 106 (e.g., on a display coupled to the device 106) that allows the user to interact with an application or applications that are running on the user device 106. In some instances, the GUI 110 may include one or more data entry fields 111 in which a user of the user device 106 may enter information (e.g., for processing by the application servers 102). The user device 106 may present a combo box element 112 for a data entry field 111 when the user interacts with the data entry field 111. A typical combo box element may, in some cases, include a drop-down list that shows selectable items (e.g., 118) for the data entry field 111 and a text input box (e.g., 113) for direct entry a value for the data entry field 111 or for searching the list of selectable items (e.g., as shown). Sometimes, a desired item might not present in the list of selectable items or may be incorrectly defined. To address the issue, a user of the user device 106 might need to close the combo box element 112 (or the element of the GUI 110 in which the combo box element 112 is displayed) and navigate to another element of the GUI 110 or application on the user device 106, interrupting the user's workflow.

Thus, in certain embodiments of the present disclosure, a combo box element of a GUI (e.g., the combo box element 112 of the GUI 110) may include a list of selectable actions (e.g., the list of selectable actions 116 of the GUI 110 or the list of selectable actions 114 of the GUI 110) to be taken with respect to selection of an item for a data entry field (e.g., the data entry field 111 of the GUI 110) in addition to the drop-down list of selectable item (e.g., 118) and the text entry/search field (e.g., 113). The list of selectable actions may be presented along with the list of selectable items or may be presented in response to an interaction with one of the selectable items. For instance, in the example shown, the list of selectable actions 116 is displayed alongside the list of selectable items 118 for the data entry field 111, while the list of selectable actions 114 may be displayed after a particular interaction with one of the items 118 is detected by the user device 106 (e.g., a user “right-clicking”, hovering, or performing another type of interaction with one of the items 118, such as Item1 in the example shown).

Selection of one of the listed actions may automatically generate a new GUI element to perform the selected action (e.g., to edit a current item/object, add a new item/object, define a listed item/object, delete a listed item/object, or select an item/object not included in the list), preventing the user from having to close the current GUI element and navigate to another GUI element or application. For example, a user may open an item/object in a new window or program to see more details, open a new window edit the object or rename the object, open a new window to select an object not listed in the combo box (e.g., open it from a new source), or open a new window to search for use of the object within a broader environment.

Through an enhanced combo box element (e.g., element 112), typical combo box functionality may be extended to not only select elements, objects, or variables for a data entry field, but may also be used to define, edit, or create new versions of these elements, directly from the same GUI element. In other words, enhanced combo box functionality as described herein may combine the functionality of what would normally involve multiple separate GUI elements into a single GUI element, making user experience (UX)/GUI design simpler and also enhancing usability and user experience of the resulting UX/GUIs.

In the example shown in FIG. 1B, the user device 106 includes a processor 152, memory 154, an I/O interface 156, and a network interface 158. The example processor 152 executes instructions, for example, to perform one or more of the functions described herein. The instructions can include programs, codes, scripts, or other types of data stored in memory. Additionally, or alternatively, the instructions can be encoded as pre-programmed or re-programmable logic circuits, logic gates, or other types of hardware or firmware components. The processor 152 may be or include a general-purpose microprocessor, as a specialized co-processor or another type of data processing apparatus. In some cases, the processor 152 may be configured to execute or interpret software, scripts, programs, functions, executables, or other instructions stored in the memory 154. In some instances, the processor 152 includes multiple processors or data processing apparatuses.

The example memory 154 includes one or more computer-readable media. For example, the memory 154 may include a volatile memory device, a non-volatile memory device, or a combination thereof. The memory 154 can include one or more read-only memory devices, random-access memory devices, buffer memory devices, or a combination of these and other types of memory devices. The memory 154 may store instructions (e.g., programs, codes, scripts, or other types of executable instructions) that are executable by the processor 152.

The example I/O interface 156 provides communication between the user device 106 and one or more other devices, such as peripheral devices connected to the user device 106. The I/O interface 156 may include one or more ports for connecting to peripheral devices, and may include a High-Definition Multimedia Interface (HDMI) port, Digital Visual Interface (DVI) port, a DisplayPort port, a Video Graphics Array (VGA) port, a S-Video port, a Universal Serial Bus (USB) port, a PS/2 port, a parallel port, a serial port, or another type of port for connecting to peripheral devices. In the example shown, for instance, the I/O interface 156 couples the user device 106 to external displays 170 that display aspects of GUIs generated by the application 160 (e.g., via GUI engine 162) or other applications that run on the user device 106, and couples the user device 106 to input devices 172 (e.g., keyboard, mouse, etc.) that are used by a user of the user device 106 to interact with the applications 160.

The example network interface 158 may include a wireless network interface or a wired network interface that provides communication between the user device 106 and the application servers 102 over the network 108. The network interface 158 may include a WIFI interface, Bluetooth interface, or other type of wireless interface, or may include a Gigabit Ethernet interface or other type of wired interface for communicating with the servers 102.

The example user device 106 runs (via the processor 152) one or more applications 160 installed on the user device 106. The applications 160 may be any type of application executable on the user device 106. In some cases, one or more of the applications 160 may interface with the application servers 102 to present information to a user of the user device 106 in a GUI displayed on the display 170. The example application 160 shown in FIG. 1B includes a GUI engine 162 and an interaction engine 164, and may also include other engines or executables as well. The GUI engine 162 may be executable by the processor 152 to generate and modify GUIs that are presented on the display 170 to a user of the user device 106, while the interaction engine 164 may be executable by the processor 152 to detect certain interactions by the user via the input devices 172 with the application 160 (e.g., with elements of a GUI generated by the GUI engine 162). The GUI engine 162 and interaction engine 164 may each include logic implemented in software, hardware, firmware, or a combination thereof.

In general, “servers,” “clients,” “computing devices,” “network elements,” “database systems,” “user devices,” and “systems,” etc. (e.g., 102, 106) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing apparatus. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, zOS, etc., as well as virtual machines and emulators adapted to virtualize execution of a particular operating system, as well as container-based operating environments (e.g., Docker containers, Kubernetes containers, etc.), and customized and proprietary operating systems among other examples.

Further, servers, clients, network elements, systems, and computing devices (e.g., 102, 106) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, application servers 102 can be at least partially (or wholly) cloud-implemented, web-based, or distributed to remotely host, serve, or otherwise manage data, software services and applications interfacing, coordinating with, dependent on, or used by other services and devices (e.g., 106) in environment 100. In some instances, a server, system, subsystem, or computing device can be implemented as some combination of devices that can be hosted on a common computing system, server, server pool, or cloud computing environment and share computing resources, including shared memory, processors, and interfaces.

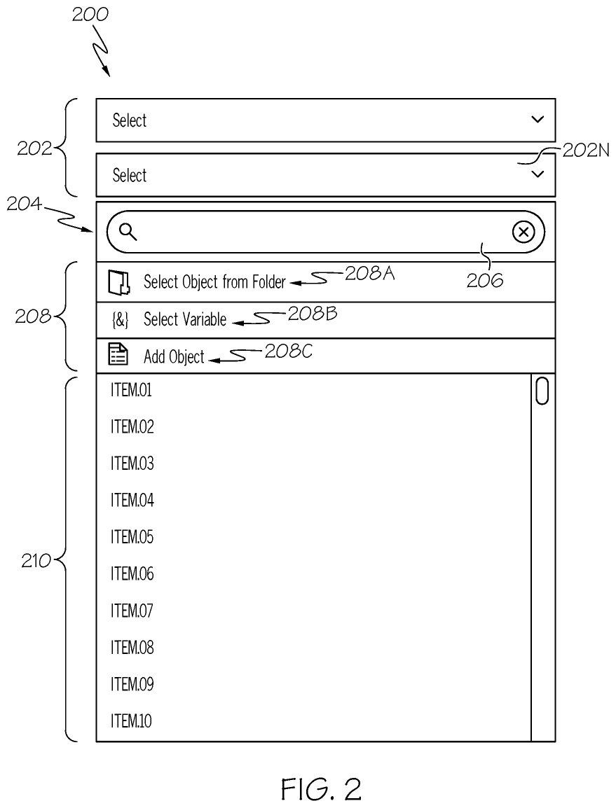

FIG. 2 is a diagram of an example enhanced combo box element 204 of a graphical user interface (GUI) 200 in accordance with at least one embodiment. In the example shown, the GUI 200 includes multiple data entry fields 202 (also referred to as selection fields, in some cases) for entry or selection of information by a user of the GUI. In some instances, when a data entry field is interacted with (e.g., clicked on by a user in the GUI), a combo box element 204 may be generated and displayed in the GUI adjacent or nearby the data entry field. For example, as shown in FIG. 2, when the data entry field 202N is clicked on by a user, the combo box element 204 is generated and displayed in the GUI near the data entry field 202N. The combo box element 204 includes a text entry field 206 in which a user can enter text to search for or select information for the data entry field 202N, a list of selectable items 210 to choose for the data entry field 202N, and a list of selectable actions 208 to be taken with respect to selection of an item for the data entry field 202N.

In some instances, a user may directly select an item for the data entry field 202N from the list of items 210. In other instances, a user may enter text into the text input field 206 to select an item for the data entry field 202N. When the user enters text into the text input field, it may be determined whether one of the items 210 corresponds to the text entered and a subset of suggested items may be shown in the combo box element 204 instead of the entire list of items 210. For example, when a user enters text into the text entry field 206 a list of results that match or otherwise contain the text entered in the field 206 may be displayed in the combo box element 204 in place of the list of items 210. For instance, if a user enters “ITEM.0” into the field 206, then the combo box element 204 may display only the subset of items 210 whose names begin with that string (i.e., not ITEM.10).

In some cases, however, a user may not see a desired item in the list of selectable items 210 or may not find the desired item via a search using the text input field 206. Accordingly, the user may wish to select one of the selectable actions 208 in order to select an item for the data entry field 202N. For instance, in the example shown in FIG. 2, the user may choose the action 208A to select an item (e.g., a database object) from another source (e.g., a different folder or directory), the action 208B to select a variable, or the action 208C to add a new item (e.g., object) to select for the data entry field 202N. The list of selectable actions may include additional, fewer, or different actions from those shown in the list of selectable actions 209.

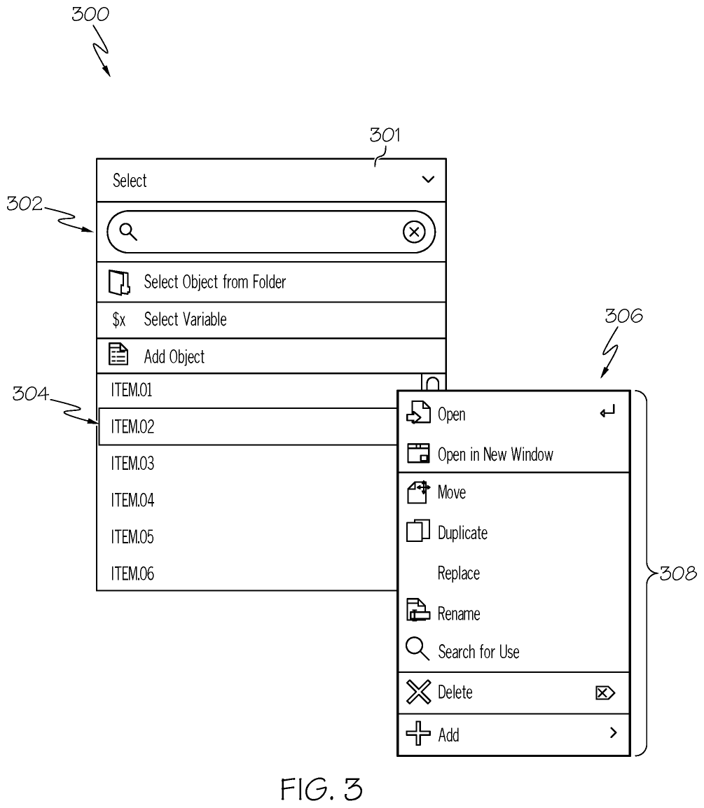

FIG. 3 is a diagram of another example enhanced combo box element 302 of a graphical user interface (GUI) 300 in accordance with at least one embodiment. The combo box element 302 is formatted similar to the combo box element 204 of FIG. 2, and additionally includes a selection element 306 with a list of selectable actions 308 to be taken with respect to a particular item 304 in the list of selectable items for the data entry field 301. The selection element 306 may be generated in response to an interaction being detected with the particular item 304. The interaction to generate the selection element 306 may be different from an interaction that would select the item 304. For example, the selection element 306 may be generated after a user right-clicks or hovers over the item 304, whereas a left-click interaction may select the item 304 for the data entry field 301. The example actions 308 to be taken with respect to the item 304 may include (as shown in FIG. 3) opening the item 304 (e.g., in the same or different GUI element), moving the item 304, duplicating the item 304, replacing the item 304, renaming the item 304, searching for use of the item 304 in another context, deleting the item 304, or adding new information to the item 304. The selection element 306 may include additional, fewer, or different actions 308 than those shown.

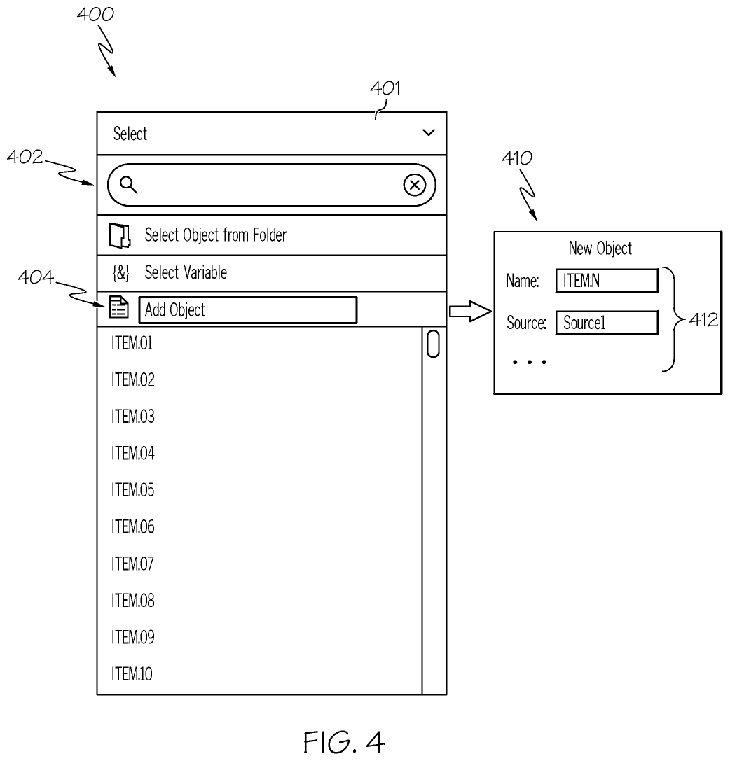

FIG. 4 is a diagram of an example action interface 410 being generated in a GUI 400 in response to selection of a selectable action 404 in an enhanced combo box element 402 for a data entry field 401 in accordance with at least one embodiment. The example combo box element 402 is formatted similar to the combo box element 204 of FIG. 2, and in the example shown, the “Add Object” action 404 has been selected by a user. In response to the selection of the action 404, the action interface 410 is generated in the GUI 400 to perform the selection action 404 (e.g., adding an object in FIG. 4). In the example shown, for instance, the action interface 410 includes a number of fields 412 (e.g., “Name”, “Source”, or other fields for defining a new object) that allow a user to define a new object, which may then be selected for the data entry field 401. The action interface 410 may be formatted in a manner that is dependent upon the selected action 404, and thus, may be formatted in another manner. As an example, if the action “Select Object from Folder” is selected, the action interface 410 may include an interface for exploring one or more directories to locate and select an object for the data entry field 401.

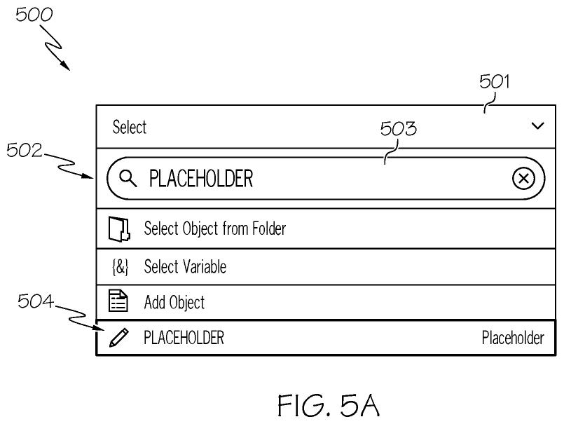

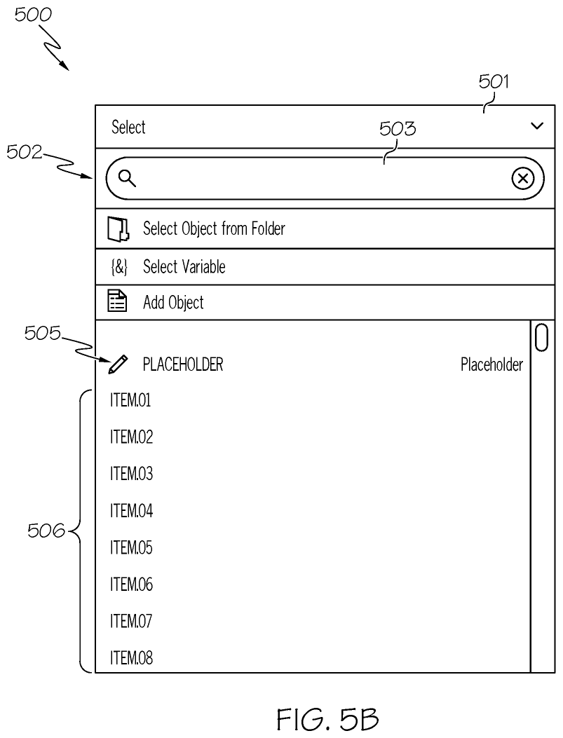

FIG. 5A-5B is a diagram of example placeholder functionality in an enhanced combo box element 502 of a GUI 500 in accordance with at least one embodiment. The combo box element 502 is formatted similar to the combo box element 204 of FIG. 2. In the example shown, a user of the combo box element 502 may enter text (e.g., “PLACEHOLDER” as shown in FIG. 5A) into the text input field 503, and may notice that no items match the entered text (e.g., through an autocompletion functionality utilized in the combo box element 502). In some embodiments, the combo box element 502 may include an option 504 to insert a placeholder item into the list of selectable items for the data entry field 501 that is named based on the text entered into the text input field 503. After the placeholder has been created, the placeholder 505 may be listed in the combo box element 502 along with (e.g., in line with) the list of selectable items 506 for the data entry field as shown in FIG. 5B. Creation of the placeholder may be different from creation of a new item in that creation of the placeholder does not actually create a new item. Instead, the placeholder may be used as a temporary selection for the data entry field (e.g., in the creation of a template) until the actual item is later created (which may be named the same as the placeholder).

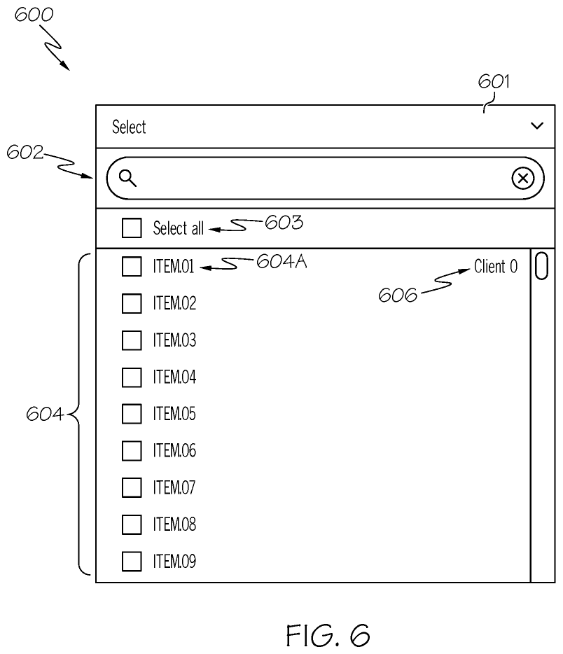

FIG. 6 is a diagram of example multiple selection functionality in an enhanced combo box element 602 of a GUI 600 in accordance with at least one embodiment. The combo box element 502 is formatted similar to the combo box element 204 of FIG. 2, and additionally includes functionality to select multiple items for the data entry field 601. For instance, in the example shown, the combo box element 602 includes an option 603 to select all items in the list of selectable items 604 for the data entry field 601, and also includes an option (via checkboxes next to each item, as shown) to select particular items 604 for the data entry field 601. In the example shown, the item 604A has a corresponding in-line indication 606 that displays information about the item 604A. The information may be any type of descriptive information, and may include, for example, a source directory of the item, a type of the item, or another type of descriptive information.

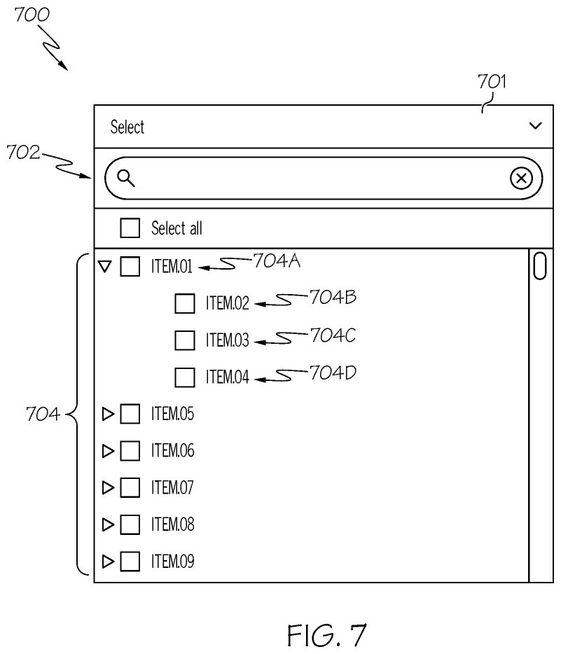

FIG. 7 is a diagram of example nested list functionality in an enhanced combo box element 702 of a GUI 700 in accordance with at least one embodiment. The combo box element 502 is formatted similar to the combo box element 204 of FIG. 2, and additionally includes the nested list functionality (as well as the multiple selection functionality described above). For instance, in the example shown, the combo box element 702 includes a list of selectable items 704, with the “parent” item 704A having multiple “nested” items 704B-D. The nesting of items may be based on a dependency between the nested items and the parent item, or may be based on another reason. In some cases, selection of the parent item 704A may, by default, select each of the nested items 704B-D.

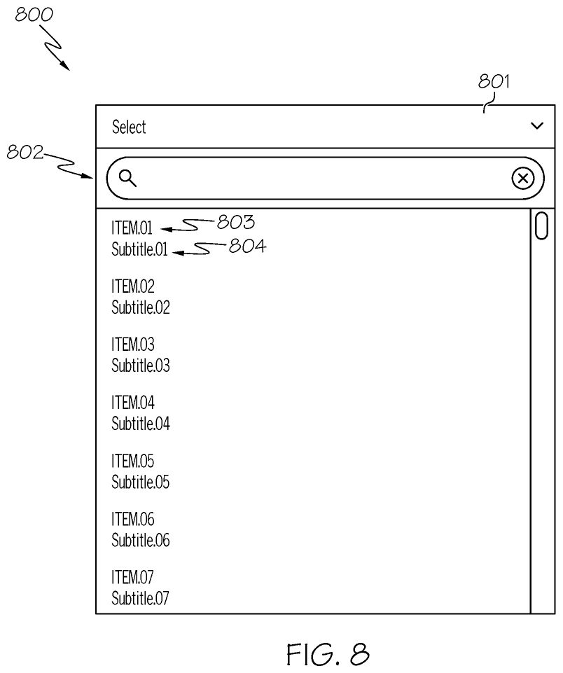

FIG. 8 is a diagram of example subtitles in an enhanced combo box element 802 of a GUI 800 in accordance with at least one embodiment. The combo box element 802 is formatted similar to the combo box element 204 of FIG. 2. In the example shown, each item (e.g., 803) includes a corresponding subtitle (e.g., 804). The subtitle may be used as a description or further description of the item, as an indication of the source of the item, or may be used to indicate other information about the item. In some cases, only certain items in the list of selectable items of the combo box may have corresponding subtitles.

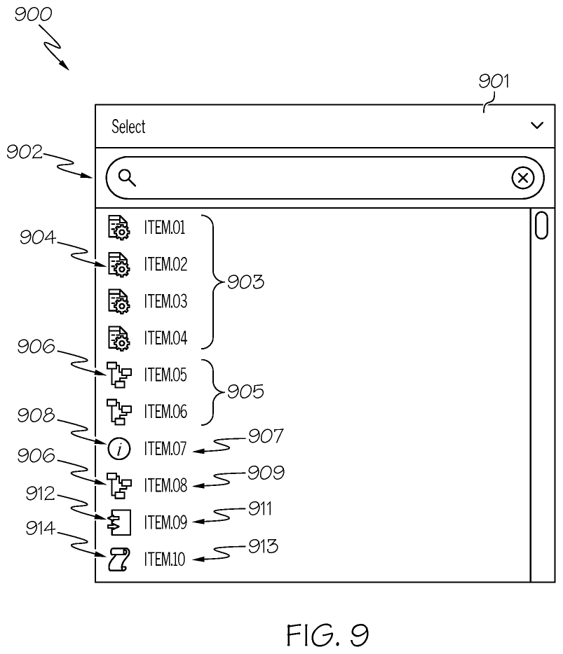

FIG. 9 is a diagram of example icons in an enhanced combo box element 902 of a GUI 900 in accordance with at least one embodiment. The combo box element 902 is formatted similar to the combo box element 204 of FIG. 2. In the example shown, each item has a corresponding icon shown near the item in the list of selectable items in the combo box element 902. For instance, the items 903 have a corresponding icon 904, the items 905, 909 have a corresponding icon 906, the item 907 has a corresponding icon 908, the item 911 has a corresponding icon 912, and the item 913 has a corresponding icon 914. The icons may indicate a type of the corresponding item/object, a source of the corresponding item/object, or other information associated with the corresponding item/object. In some cases, only certain items in the list of selectable items of the combo box may have corresponding icons.

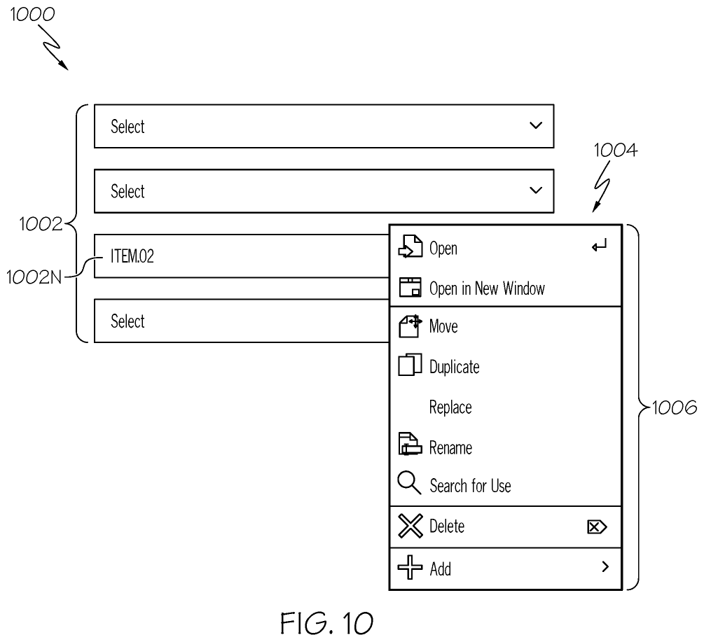

FIG. 10 is a diagram of an example selection interface element 1004 being generated in response to detection of an interaction with a data entry field 1002N in accordance with at least one embodiment. In the example shown, the GUI 1000 includes multiple data entry fields 1002, and an item (ITEM.02) has already been selected for the data entry field 1002N. In some embodiments, when a user interacts with the data entry field 1002N (e.g., right-clicks the data entry field 1002N) after the selection of the item, a number of selectable actions 1006 may be listed the selection interface element 1004. The actions 1006 may be actions to be taken with respect to the selected item for the data entry field 1002N. In some embodiments, the actions 1006 to be taken with respect to the selected item for the data entry field 1002N may include (as shown in FIG. 10) opening the item (e.g., in the same or different GUI element), moving the item, duplicating the item, replacing the item, renaming the item, searching for use of the item in another context, deleting the item, or adding new information to the item. The selection interface element 1004 may include additional, fewer, or different actions 1006 than those shown.

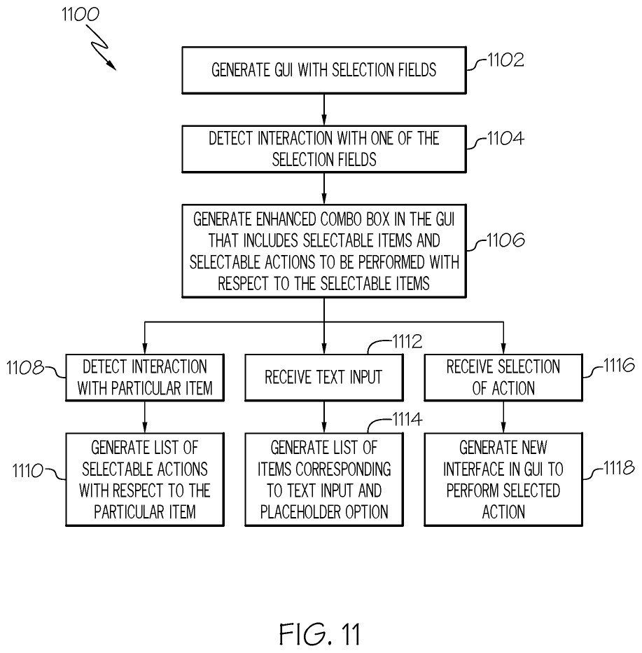

FIG. 11 is a diagram of an example process 1100 of generating an enhanced combo box element in a GUI in accordance with at least one embodiment. Operations in the example process 1100 may be performed by components of a computing device (e.g., the device 106 of FIGS. 1-2). The example process 1100 may include additional or different operations, and the operations may be performed in the order shown or in another order. In some cases, one or more of the operations shown in FIG. 11 are implemented as processes that include multiple operations, sub-processes, or other types of routines. In some cases, operations can be combined, performed in another order, performed in parallel, iterated, or otherwise repeated or performed another manner.

At 1102, a GUI is generated. The GUI may include one or more selection fields or data entry fields, which may prompt a user of the GUI to select items or otherwise enter information into the fields. The fields in the GUI may look similar to the fields 1002 of FIG. 10, for example.

At 1104, an interaction with one of the selection fields is detected. The interaction may include a “left-click” interaction from a mouse coupled to a computing device, a “tap” interaction on a tablet or smartphone device, or another type of interaction that indicates a user's intention to select an item for the field or enter information for the field.

At 1106, an enhanced combo box element is generated in the GUI. The enhanced combo box element may include both a list of one or more selectable items and a list of one or more selectable actions to be performed with respect to those items. For example, the combo box element may be formatted similar to one or more of the combo box elements 204, 302, 402, 502, 602, 702, 802, or 902 shown in FIGS. 2, 3, 4, 5A-5B, 6, 7, 8, 9, respectively, and described above. The actions may include selecting a source location (e.g., a new folder or directory) from which to select an item for the field, creating a new item to select for the field, selecting a variable for the field, or another type of action. In some cases, the list of actions may be formatted similar to the list of actions 208 of FIG. 2.

In some embodiments, the combo box element may include indications which may indicate information about the item. The indications may be indicated in-line with the item within the combo box (e.g., indication 606 of FIG. 6), as a subtitle to the item within the combo box (e.g., subtitle 804 of FIG. 8), or presented in another manner (e.g., when the item is “hovered over” by a user). In some embodiments, the combo box element may include multiple selection functionality, and may accordingly include selection boxes for selecting multiple of the listed selectable items (e.g., as shown in FIG. 6 and described above). In some embodiments, the list of selectable items may be displayed in a logical tree structure, such as in a nested format (e.g., as shown in FIG. 7 and described above). In some embodiments, one or more of the selectable items listed may have a corresponding icon displayed near the item, with the icon indicating a type or other information about the item (e.g., as shown in FIG. 9 and described above).

At 1108, an interaction with a particular item in the list of selectable items is detected, and at 1110, a list of selectable actions to be performed with respect to that particular item is generated. The list of actions may be generated in a new interface in response to detecting the interaction with the item. The interaction may be of a different type than an interaction to select the particular item for the field. For instance, the list of actions may be generated after a user right-clicks or hovers over the item, whereas a left-click interaction may select the item for the field. The listed actions may include opening the item (e.g., in the same or different GUI element), moving the item, duplicating the item, replacing the item, renaming the item, searching for use of the item in another context, deleting the item, adding new information to the item, or another type of action. In some cases, the list of actions may be formatted similar to the list of actions 308 of FIG. 3.

At 1112, text input is received in the enhanced combo box, and at 1114, a list of items corresponding to the text input is generated along with a placeholder option. The placeholder option may be presented by default or may be presented in response to a determination that the entered text does not correspond to a selectable item in the list. The text input may be received at a text input field of the enhanced combo box element (e.g., the text input field 503 in the combo box element 502 of FIGS. 5A-5B). In some cases, the combo box element may include an autocompletion functionality that lists items that match the text input into the text input field and may accordingly list the items corresponding to the text input in real time or near real time. The placeholder option may be similar to the placeholder option 504 of FIG. 5A and described above. If the placeholder option is selected, a placeholder may be created for the entered text and a user may go back at a later time to create an item to be used instead of the placeholder.

At 1116, a selection of a particular action in the list of selectable actions in the combo box element is received, and at 1118, a new interface in the GUI is generated to perform the selected action (e.g., as shown in FIG. 4 and described above)). The newly generated interface may be formatted in a way that allows a user to perform the particular selected action and may accordingly have a format dependent upon the selected action. The new interface may be generated as a new window or as a new element within a current window. By generating the new interface in this manner, a user may avoid interruptions in their workflow, such as those caused by having to close windows and open new windows to perform the selected action.

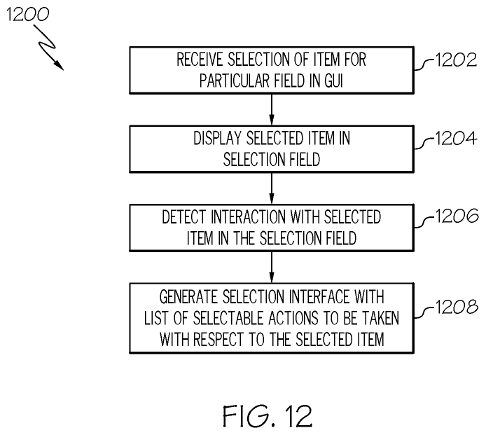

FIG. 12 is a diagram of an example process 1300 of generating a selection interface for a selected item in data entry field in accordance with at least one embodiment. Operations in the example process 1200 may be performed by components of a computing device (e.g., the device 106 of FIGS. 1-2). The example process 1200 may include additional or different operations, and the operations may be performed in the order shown or in another order. In some cases, one or more of the operations shown in FIG. 12 are implemented as processes that include multiple operations, sub-processes, or other types of routines. In some cases, operations can be combined, performed in another order, performed in parallel, iterated, or otherwise repeated or performed another manner.

At 1202, a selection of an item for a particular data entry field or selection field in a GUI is received. The selection may be made using a traditional combo box element or by an enhanced combo box element as described herein. For instance, the selection may be made by entering text into a text input field of a combo box element or by selecting the item from a list of items displayed within the combo box element.

At 1204, the item selected at 1202 is displayed in the field. Referring to FIG. 10 for example, the item “ITEM.02” may be displayed in the field 1002N after being selected for the field 1002N.

At 1206, an interaction is detected with the selected item in the particular field. The interaction may be of a different type than an interaction to select the particular item for the field. For instance, the list of actions may be generated after a user right-clicks or hovers over the item, whereas a left-click interaction may select the item for the field.

At 1208, a selection interface is generated based on the interaction detected at 1206. The selection interface may include a list of selectable actions to be taken with respect to the selected item for the particular field. The listed actions may include opening the item (e.g., in the same or different GUI element), moving the item, duplicating the item, replacing the item, renaming the item, searching for use of the item in another context, deleting the item, adding new information to the item, or another type of action. In some cases, the list of actions may be formatted similar to the list of actions 1006 of FIG. 10. If an action is selected from the list, a new interface may be generated in the GUI to perform the selected action (e.g., as described above with respect to 1116 and 1118 of FIG. 11).

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
presenting an interactive graphical user interface (GUI) on a display coupled to a computing device, the GUI comprising a selection field for selection of one or more items;
receiving an interaction with the selection field;
presenting a selection interface in the GUI based on the interaction with the selection field, the selection interface comprising:
a list of selectable items associated with the selection field; and
a list of selectable actions to be taken with respect to selection of an item for the selection field;
receiving a selection of a particular action in the list of selectable actions; and
presenting an action interface in the GUI based on selection of the particular action, the action interface for performing the particular action.

2. The method of claim 1, wherein the selectable actions includes one or more of: selecting a location from which to select an item for the selection field and creating a new selectable item.

3. The method of claim 1, wherein the selection interface is a first interface of the GUI, the action interface is a second interface of the GUI, and the method further comprises:
receiving an interaction with a particular selectable item in the first interface; and
presenting a third interface in the GUI, the third interface comprising a list of selectable actions to be taken with respect to the particular selectable item.

4. The method of claim 3, wherein the list of selectable actions includes opening the particular selectable item in another interface of the GUI, modifying aspects of the particular selectable item, duplicating the particular selectable item, and deleting the particular selectable item.

5. The method of claim 1, wherein the selection interface comprises a text input field, and the method further comprises:
receiving input at the text input field; and
displaying a placeholder option for the received input based on a determination that the received input does not correspond to a selectable item.

6. The method of claim 1, wherein the selection interface includes an indicator for at least one of the selectable items, the indicator being in-line with the selectable item in the selection interface and indicating information about the selectable item.

7. The method of claim 1, wherein the selection interface includes two lines for a particular selectable item, a first line indicating the selectable item and a second line indicating information about the selectable items.

8. The method of claim 1, wherein the selection interface comprises selection boxes for selecting a plurality of the selectable items.

9. The method of claim 1, wherein the list of selectable items is displayed in a logical tree structure.

10. The method of claim 1, wherein the selection interface comprises an icon displayed next to one or more of the selectable items, the icon indicating a type of the selectable item.

11. The method of claim 1, further comprising:
receiving, in the selection interface, a selection of an item for the selection field;
displaying the selected item in the selection field;
receiving another interaction with the selection field; and
presenting another selection interface comprising a list of selectable actions to be taken with respect to the selected item in the selection field.

12. A non-transitory computer readable medium having program instructions stored therein, wherein the program instructions are executable by a computer system to perform operations comprising:
detecting user interaction with a data entry field of a graphical user interface (GUI); and
generating a combo box element near the data entry field in the GUI based on detection of the interaction, the combo box element comprising:
a text input field;
a list of selectable items; and
a list of selectable actions to be taken with respect to selection of an item for the data entry field;
detecting a selection of a particular action in the list of selectable actions; and
generating an action element in the GUI based on selection of the particular action, the action element for performing the particular action.

13. The non-transitory computer readable medium of claim 12, wherein the list of selectable actions includes one or more of: selecting a location from which to select an item for the data entry field, creating a new selectable item, opening a particular selectable item in another element of the GUI, modifying aspects of a particular selectable item, duplicating a particular selectable item, and deleting a particular selectable item.

14. The non-transitory computer readable medium of claim 12, wherein the operations further comprise:
detecting interaction with a particular selectable item in the combo box element; and
generating a selection element near the combo box element in the GUI based on the detection, selection element comprising a list of selectable actions to be taken with respect to the particular selectable item.

15. The non-transitory computer readable medium of claim 12, wherein the operations further comprise:
determining whether an item of the list of selectable items matches text input received in the text input field;
displaying a subset of items of the list of selectable items based on a determination that the received text input corresponds to the items of the subset; and
displaying a placeholder option based on a determination that the received text input does not correspond to a selectable item.

16. The non-transitory computer readable medium of claim 12, wherein the operations further comprise:
detecting a selection of an item for the data entry field;
modifying the GUI to display the selected item as a selection for the data entry field;
detecting another interaction with the data entry field; and
generating a selection element in the GUI comprising a list of selectable actions to be taken with respect to the selected item for the data entry field.

17. A system comprising:
a data processing apparatus;
a memory; and
computer program code, executable by the data processing apparatus to:
detect user interaction with a data entry field of a graphical user interface (GUI);
generate a combo box element near the data entry field in the GUI based on detection of the interaction, the combo box element comprising:
a text input field;
a list of selectable items; and
a list of selectable actions to be taken with respect to selection of an item for the data entry field;
detect a selection of a particular action in the list of selectable actions; and
generate an action element in the GUI based on selection of the particular action, the action element for performing the particular action.

18. The system of claim 17, wherein the list of selectable actions includes selecting a location from which to select an item for the data entry field, creating a new selectable item, opening a particular selectable item in another element of the GUI, modifying aspects of a particular selectable item, duplicating a particular selectable item, and deleting a particular selectable item.

19. The system of claim 17, wherein the computer program code is further executable by the data processing apparatus to:
detect interaction with a particular selectable item in the combo box element; and
generate a selection element near the combo box element in the GUI based on the detection, selection element comprising a list of selectable actions to be taken with respect to the particular selectable item.

20. The system of claim 17, wherein the computer program code is further executable by the data processing apparatus to:
determine whether an item of the list of selectable items matches text input received in the text input field;
display a subset of items of the list of selectable items based on a determination that the received text input corresponds to the items of the subset; and
display a placeholder option based on a determination that the received text input does not correspond to a selectable item.
